(19) United States
(12) Patent Application Publication
(10) Pub. No.: US 2010/0121909 A1
(43) Pub. Date: May 13, 2010

(54) STORAGE APPARATUS AND ON-LINE CLIENT SERVICE SYSTEM, SOFTWARE AND METHOD THEREOF

(75) Inventors: Yu-Lung Tsai, Taipei City (TW); Ren-Wei Chen, Taipei County (TW)

Correspondence Address: J C PATENTS, 4 VENTURE, SUITE 250, IRVINE, CA, 92618, US

(73) Assignee: TRANSCEND INFORMATION , INC., Taipei (TW)

(21) Appl. No.: 12/403,203

(22) Filed: Mar. 12, 2009

(30) Foreign Application Priority Data
Nov. 13, 2008 (TW) 97143936

(51) Int. Cl. G06F 15/16; G06F 17/30

(52) U.S. Cl. 709/203; 709/227; 707/E17.108

(57) ABSTRACT

An on-line client service method of a storage apparatus that includes detecting the current status of the storage apparatus when a link is established between a client host and the storage apparatus and determining whether or not a diagnostic event has occurred, and when the diagnostic event occurs, a diagnostic result is generated. In addition, the diagnostic result is transmitted to a far-end server to process the storage apparatus properly according to the diagnostic result.

### CROSS-REFERENCE TO RELATED APPLICATION

This application claims the priority benefit of Taiwan application serial no. 97143936, filed Nov. 13, 2008. The entirety of the above-mentioned patent application is hereby incorporated by reference herein and made a part of specification.

### BACKGROUND OF THE INVENTION

1. Field of the Invention

The present invention relates to a repairing method of a storage apparatus. More specifically, the present invention relates to a repairing method of a storage apparatus that proceeds on-line.

2. Description of Related Art

A flash drive is a small, portable, computer peripheral storage device. The flash drive is mostly compliant to the standard universal serial bus (USB) communication interface. The flash drive may also be bridged to a computer platform equipped with a USB connection port, for example, a desktop personal computer, a notebook computer, a personal digital assistant (PDA), etc, to provide a user with a plug-and-play (PnP) type external data storage function. The flash drive has become a popular computer peripheral storage device in the present consumer market of computers as the flash drive is small, light, easy to carry around, and does not require external power supply or driver program installation to the computer platform.

Currently, the flash drive mostly uses a flash memory as its storage device. The flash memory itself includes a plurality of blocks. There are about eight thousand blocks in a 128 Mb flash memory device. Moreover, each of the blocks can be divided into a plurality of pages that generally ranges from 8 to 64 pages. When reading data from the flash memory, first, the location of the block to be read is to be identified, and the page to be read is searched from the target block. In order for the data reading to proceed successfully, a configure data is stored in the flash memory. When the data is written into or reading from the flash memory, the configure data is used to find the target block and page.

In light of the foregoing, when the configure data is damaged, the flash drive can not perform data writing and reading normally. As the configure data concerns the trade secret of each manufacturer, it can not be given to the user randomly. Therefore, in the conventional technique, when the configure data of the flash drive is damaged or lost, the user can not maintain the flash drive by himself/herself, but needs to send the flash drive to the maintenance center for maintenance. These actions are not only time and labor consuming, but the user also worries about whether or not the data stored in the flash drive would be disclosed.

### SUMMARY OF THE INVENTION

According to the foregoing description, the present invention provides an on-line client service system, an on-line client service software product, and an on-line client service method, so that a user can recover, repair, or update the data in the storage apparatus by himself/herself.

The present invention provides an on-line client service system of a storage device including a client host(i.e. host device in the client side), a far-end server, and a far-end database. The client host can be linked to the far-end server through a network, and the far-end server can also be coupled to the far-end database. When the storage apparatus is coupled the client host through a data interface, the client host downloads a client service application software through the network to diagnose the storage apparatus and generate a diagnostic result. Consequently, the far-end server can search for a solution from the far-end database based on the diagnostic result and transmit the solution back to the client host. The client service application software then uses this solution to perform proper processing of the storage apparatus.

From another perspective, the present invention provides an on-line client service software product of a storage apparatus that can be downloaded from a far-end server to a client host. The present invention includes an interface module, a diagnostic module, and a processing module. The interface module can establish a link with the storage apparatus when the storage apparatus is coupled to a client host through a data transmission interface. Moreover, the diagnostic module may be coupled to the interface module to diagnose the storage apparatus and generate a diagnostic result when the link is established between the storage apparatus and the interface module. Thus, the diagnostic result can be transmitted to the far-end server by the processing module, and in turn leads the far-end server to search for the solution. When the far-end server has found a preferred solution, the solution found can be transmitted back to the on-line client service software. As a consequence, the processing module may perform proper processing of the storage apparatus through the interface module based on the solution found.

In one embodiment of the present invention, the interface module can receive a device identification information regarding the storage apparatus inputted by the client host. With the machine identification information, the processing module can search for a device model and data thereof related to the storage apparatus from the database through the far-end server.

Furthermore, the data transmission interface aforementioned may be a universal serial bus (USB).

From another perspective, the present invention also provides an on-line client service method of a storage apparatus including that when a client host successfully establishes a link with the storage apparatus, the current status of the storage apparatus can be detected, whether or not an on-line diagnostic event has occurred is determined, and a diagnostic result is generated. The diagnostic result can be transmitted to a far-end server to perform proper processing of the storage apparatus.

The present invention can perform direct diagnosis of the storage apparatus when the storage apparatus is coupled to the client host and search for the solution from the far-end server to perform proper processing of the storage apparatus. Therefore, the user only needs to establish the link between the storage apparatus and the client host, and the present invention can then rapidly perform maintenance of the storage apparatus and ensure data safety.

To make the above and other features and advantages of the present invention more comprehensible, several embodiments accompanied with figures are detailed as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural diagram of an on-line client service system according to one embodiment of the present invention.

FIG. 2 is a schematic structural diagram of a far-end server system according to one embodiment of the present invention.

FIG. 3 is a functional block diagram of an on-line client service software product according to one embodiment of the present invention.

FIG. 4 is a flow diagram of an on-line client service method according to one embodiment of the present invention.

FIG. 5 is a flow diagram of processing the storage apparatus based on a diagnostic result according to one embodiment of the present invention.

### DESCRIPTION OF EMBODIMENTS

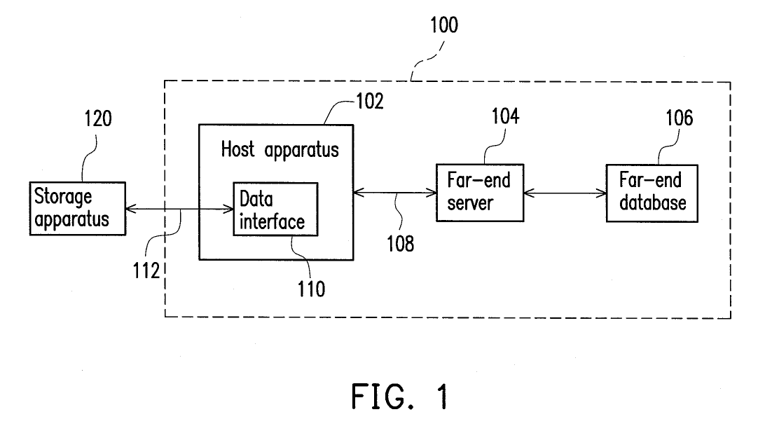

FIG. 1 is a schematic structural diagram of an on-line client service system according to one embodiment of the present invention. Referring to FIG. 1, an on-line client service system 100 provided in the present embodiment is suitable for a portable storage apparatus 120. The storage apparatus 120 may be a flash drive or an audio player, for example, a mp3 player. The on-line client service system 100 includes a client host apparatus 102, a far-end server 104, and a far-end database 106. The host apparatus 102 may be a personal computer or a portable computer. The host apparatus 102 can be coupled to the far-end server 104 through a network 108. Moreover, the far-end server 104 can also be coupled to the far-end database 106.

The host apparatus 102 located on the client side has a data interface 110 and the host apparatus 102 can be coupled to a data transmission interface 112. Thus, the storage apparatus 120 can then be coupled to the host apparatus 102 through the data transmission interface 112. In some embodiments, the data transmission interface 112 may be embodied with the USB.

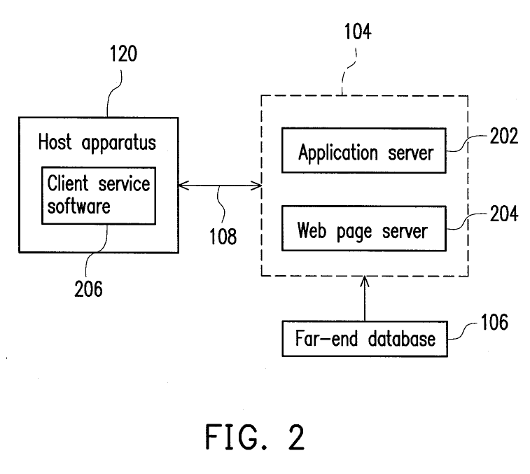

FIG. 2 is a schematic structural diagram of a far-end server system according to one embodiment of the present invention. Referring to FIG. 2, the far-end server 104 may include a web page server 202 and an application server 204. When a user transmits information with the host apparatus 102 to the far-end server 104 through the network 108, the web page server 202 can send a web page frame to the host apparatus 102 on the client side through the network 108. So, the current system information is displayed to the user and the user is allowed to input data through this web page frame. In addition, in the present embodiment, the host apparatus 120 may also download and install a client service software 206 from the far-end server (i.e., the application server 204).

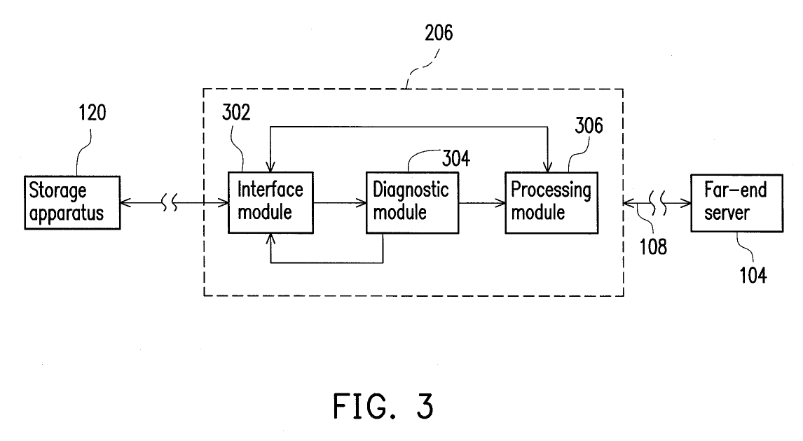

FIG. 3 is a functional block diagram of a client service software product according to one embodiment of the present invention. Referring to FIG. 3, the client service software 206 provided in the present embodiment includes an interface module 302, a diagnostic module 304, and a processing module 306. Here, the interface module 302 can be coupled to the diagnostic module 304 and the processing module 306 while the diagnostic module 304 can also be coupled to the processing module 306. Moreover, the processing module 306 may also be coupled to the far-end server through the network 108.

Referring to both FIG. 2 and FIG. 3, when the client service software 206 is downloaded from the far-end server 104 to the host apparatus 120, the diagnostic module 304 can use the interface module 302 to determine whether or not the storage apparatus 120 is coupled to the host apparatus 102 through the data transmission interface 112 indicated in FIG. 1. If the storage apparatus 120 is coupled to the host apparatus 102 through the data transmission interface 112, then the interface module 302 can establish the link with the storage apparatus 120 and demand the far-end server 104 to send a web page or download a client service software through the network 108. The web page or the client service software can provide an operation frame on the display panel of the host apparatus 102. In the present embodiment, the operation frame provided by the interface module 302 can display the current system information to the user, and also display the diagnostic result generated by the diagnostic module. Furthermore, the operation frame may also demand the user to input device identification information regarding the storage apparatus 120, for instance, device identification code, device manufacture serial number, etc. Generally, each of the storage apparatuses is endowed with a unique machine identification information during manufacture process in the factory.

When the user inputs the device identification information related to the storage apparatus 120, the client service software 206 can transmit the device identification information to the far-end server 104 through the processing module 304. By doing so, the far-end server 104 can search for data regarding the storage apparatus 120 from the far-end database 106 base on the device identification information.

When the far-end server 106 confirms the related data of the storage apparatus 120, the information can be transmitted back to the client service software 206 through the network 108. When the client service software 206 acquires the device identification information regarding the storage apparatus 120, the processing module 304 can recover, repair, and update the current status of the storage apparatus 120 through the interface module 302.

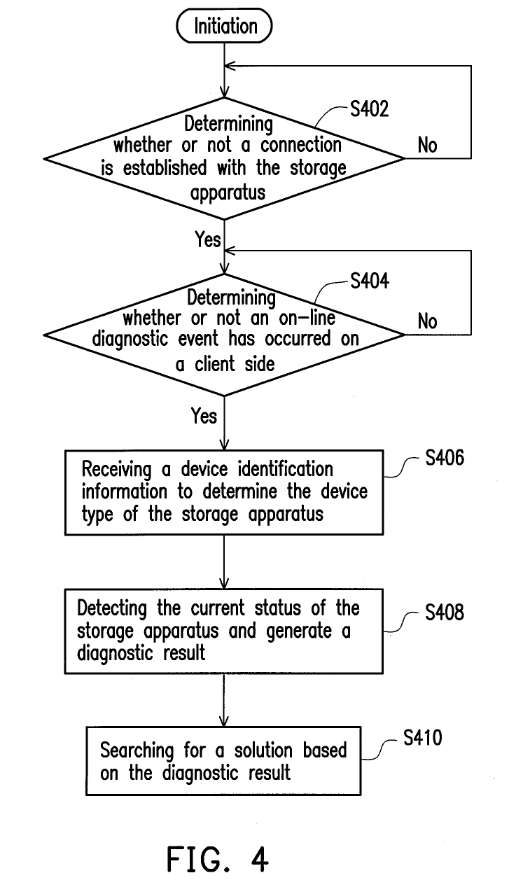

According to the aforementioned description, the present invention also provides a flow diagram of an on-line client service method as shown in FIG. 4. Referring to FIG. 4, in the present embodiment, first, as described in step S402, determine whether or not the link is established with the storage apparatus. When the link is successfully established with the storage apparatus (as indicated by the “Yes” in step S404), then the step S404 can be proceeded, that is, determine whether or not an on-line diagnostic event has occurred on a client side. Herein, the on-line diagnostic event in step S404 may be that, for example, the far-end server 104 is initiated, and the client service software 206 is installed to the host apparatus 102 as indicated in FIG. 2. When the on-line diagnostic event occurs (as indicated by the “Yes” in step S404), the present embodiment may receive device identification information regarding the storage apparatus to determine the device model of the storage apparatus as described in step S406. After the confirmation of the device model of the storage apparatus, the present embodiment can further detect the current status of the storage apparatus and generate a diagnostic result as indicated in step S408. At this moment, the solution is searched based on the diagnostic result to perform proper processing of the storage apparatus as indicated in step S410.

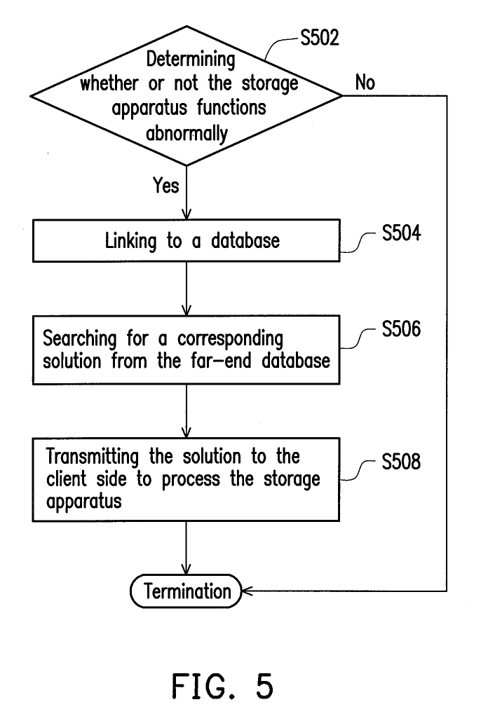

FIG. 5 is a flow diagram of the step S410 of FIG. 4 in detail according to one embodiment. Referring to FIG. 5, when receiving the diagnostic result as indicated in FIG. 4, first, determine whether or not the storage apparatus is abnormal based on the diagnostic result as indicated in step S502. If it is determined that no abnormality has occurred in the storage apparatus (as indicated by the “No” in step S502), then the entire process is terminated. On the contrary, if it is determined that abnormality has occurred in the storage apparatus (as indicated by the “Yes” in step S502), then the step S504 can be proceeded. Thus, the storage apparatus is linked to a far-end database to search for a corresponding solution, that is, the step S506. Next, the present embodiment can transmit the solution found to the client side to process the storage apparatus as indicated in step S508.

The specific embodiment of the step S508 in FIG. 5 may be processed differently based on the actual circumstances. In the present invention, several embodiments are provided as follows to illustrate the step S508 specifically. However, it should be known to people skilled in the art that the following embodiments are merely used to illustrate the execution of the step S508, and the embodiment of the present invention is not limited thereto.

### First Embodiment

If the reason for the apparatus to function abnormally is determined to be due to the internal system data (ex., configure data) damage, then, the present embodiment can extract a backup data from a far-end database and rewrite the backup data to the storage apparatus to recover the storage apparatus back to its original status.

### Second Embodiment

If the reason for the apparatus to function abnormally is determined to be due to the internal firmware issue (ex., outdated version), then the present embodiment can extract an update data from the far-end database. When the update data is acquired, the update data is then transmitted to the storage apparatus to update the internal firmware.

Although in the above embodiments, the client service software is installed in a client host, it does not limit the present invention. In other embodiments, the client service software may also be installed directly in the storage apparatus. Consequently, when the storage apparatus is coupled to a client host, the user can initiate the client service software installed in the storage apparatus and execute the steps aforementioned.

In summary, as the present invention can recover, update, or repair the storage apparatus on-line, the present invention has higher convenience. Moreover, due to the method used in the present invention, the user does not need to send the apparatus back to the original manufacturer for the processing. So, the user does not need to worry about data disclosure. On the contrary, to the manufacturer, the user only downloads the data related to the device model when processing the storage apparatus, and does not need to download other software corresponding to unrelated device models.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An on-line client service system of a storage apparatus, comprising:
a client host, having a data transmission interface;
a far-end server, linked to the client host through a network to diagnose the storage apparatus, comprising:
a web page server, transmitting a web page frame to the client host through the network when the far-end server is initiated to display information and receive data from the client host; and
an application server; and
a far-end database, linked to the far-end server,
wherein when the far-end server is initiated and the storage apparatus is coupled to the client host through the data interface, the client host downloads a client service application software from the application server through the network to diagnose the storage apparatus and generates a diagnostic result transmitted back to the application server searching for a solution in the database based on the diagnostic result with the far-end server to process the storage apparatus properly.

2. The on-line client service system of claim 1, wherein the client host is a personal computer.

3. The on-line client service system of claim 1, wherein the client host is a portable computer.

4. The on-line client service system of claim 1, wherein the data transmission interface is a universal serial bus (USB).

5. The on-line client service system of claim 1, wherein the client service application software is installed in the web page server or the application server for users to download.

6. The on-line client service system of claim 1, wherein the client service application software is installed in the web page server and transmitted a web page to the client host through the network.

7. The on-line client service system of claim 1, wherein the client service application software is installed in the far-end server.

8. The on-line client service system of claim 1, wherein the processing of the storage apparatus by the host includes repairing, updating, and data recovering.

9. An on-line client service software product of a storage apparatus suitable for downloading from a far-end server to a client host, comprising:
an interface module, establishing a link with the storage apparatus when the storage apparatus is coupled to the client host through a data transmission interface;
a diagnostic module, coupled to the interface module to diagnose the storage apparatus when a link is established between the storage apparatus and the interface module and generating a diagnostic result; and
a processing module, coupled to the diagnostic module to receive the diagnostic result and transmitted the diagnostic result to the far-end server,
wherein the far-end server has a web page server transmitting a web page to the client host through the data transmission interface as the fare-end server being initiated to display information and receiving data from the client host, and an application server receiving the diagnostic result for searching for a solution, so that the processing module performs proper processing of the storage apparatus through the interface module based on the solution found.

10. The on-line client service system of claim 9, wherein the data transmission interface is a universal serial bus (USB).

11. The on-line client service software product of claim 9, wherein the interface module further receives a device identification information regarding the storage apparatus input by the client host.

12. The on-line client service software product of claim 11, wherein the processing module further transmits the device identification information back to the far-end server to search for device model and data thereof regarding the storage apparatus.

13. The on-line client service software product of claim 9, wherein the processing module performs repairing, updating, and data recovering of the storage apparatus based on the solution found.

14. The on-line client service software product of claim 9, wherein the storage apparatus is a flash drive or an audio player.

15. An on-line client service method of a storage apparatus, comprising the following:
establishing a link between a client host and the storage apparatus and detecting the current status of the storage apparatus;
determining whether or not a diagnostic event has occurred;
generating a diagnostic result when the diagnostic event occurs;
providing a web page server for transmitting a web page frame to the client host or receiving data from the client host when the link is established;
providing a application server for receiving the diagnostic result;
determining whether or not the storage apparatus functions abnormally based to the diagnostic result;
searching for a corresponding solution when the storage apparatus functions abnormally; and
providing the solution found to the client host to perform proper processing of the storage apparatus.

16. The on-line client service method of claim 15, comprising: downloading a client service application software from a network and diagnosing the storage apparatus, generating a diagnostic result when the diagnostic event occurs to perform the diagnosis and processing of the storage apparatus.

17. The on-line client service method of claim 15, wherein the step of determining whether or not the link is established with the storage apparatus further comprises detecting whether or not the storage apparatus is coupled to a client host through a data transmission interface.

18. The on-line client service method of claim 17, wherein the data transmission interface is a universal serial bus (USB).

19. The on-line client service method of claim 15, wherein when the link is successfully established with the storage apparatus, further comprising receiving a device identification information regarding the storage apparatus from the client host to determine the device model of the storage apparatus.

20. The on-line client service method of claim 15, wherein the solution comprises:
extracting a backup data from the far-end server; and
transmitting the backup data back to the storage apparatus through a network to recover the data lost from the storage apparatus.

21. The on-line client service method of claim 15, wherein the solution comprises:
extracting an updating data from the far-end server; and
transmitting the updating data back to the storage apparatus through a network to update a firmware in the storage apparatus.

22. The on-line client service method of claim 15, wherein the solution comprises:
extracting a repairing data from a database; and
repairing the error occurred in the storage apparatus based on the repairing data transmitted to the storage apparatus through a network.

23. The on-line client service method of claim 15, wherein the storage apparatus is a flash drive or an audio player.

24. A storage apparatus with a characteristic that the storage apparatus is performed a self diagnosis for obtaining a diagnostic result when the storage apparatus is coupled to a client host, and the diagnostic result is transmitted to a far-end server by the client host to perform proper processing of the storage apparatus,
wherein, the far-end server comprising:
a web page server, transmitting a web page frame to the client host through the network when the far-end server is initiated to display information and receiving data from the client host; and
an application server, used to receive the diagnostic result and search for a solution from the far-end server based on the diagnostic result for performing the proper processing of the storage apparatus.
